(19) United States
(12) Patent Application Publication
(10) Pub. No.: US 2011/0281478 A1
(43) Pub. Date: Nov. 17, 2011

(54) SYSTEMS, DEVICES AND METHODS FOR PROVIDING ENERGY FOR SHIP PROPULSION

(76) Inventor: Benjamin Blumenthal, Atlanta, GA (US)

(21) Appl. No.: 12/781,404

(22) Filed: May 17, 2010

(51) Int. Cl. B63H 19/00; B64C 31/06; B63J 1/00; B63H 1/14; G06F 19/00; B63H 19/02; B63H 21/17

(52) U.S. Cl. 440/6; 440/113; 440/9; 244/153 R; 440/49; 701/21

(57) ABSTRACT

The present invention allows for the replacement of polluting and inefficient diesel-based marine propulsion systems. A natural-gas burning power plant in combination and at least one renewable energy source are combined to drive a ship's propulsion during times when the power plants are not in use for other activities including desalination and oil exploration. Renewable energies are used judiciously to reduce fossil fuel requirements but the present invention does not fully rely on renewable energy, which is not always available.

### FIELD AND BACKGROUND OF THE INVENTION

The present invention relates to the field of ship propulsion in general and environmentally cleaner ship energy usage in particular.

Hundreds of thousands of freighters ply the world's waters. Virtually all of them burn diesel fuel to drive their large and generally inefficient propulsion systems.

Data for a popular ship engine produced in Japan show that it requires over 1,600 gallons of diesel fuel per hour to run (http://people.bath.ac.uk/ccsshb/12cvl/).

U.S. Pat. No. 5,235,266 to Schaffrin describes an energy-generating plant including a solar generator, having solar cells, for producing electrical energy. The electrical energy is supplied to a direct current converter, the output power of which may be used to charge an energy storage system, such as batteries. The input resistance of the direct current converter is adapted, such as by a microcomputer, to the maximum power point (MPP) of the solar generator, the MPP being dependent upon the solar insulation and the temperature of the solar cells. At start up of the plant, or when there is a change of power at the output of the direct current converter, a search process is carried out to attain the MPP of the solar generator. The energy storage system may be used to energize an electric motor for driving the propeller of a ship.

U.S. Pat. No. 6,561,856 to Gorshkov describes an invention for using additional forms of energy for ship propulsion. In his words: to access the inexhaustible energy source like seas and oceans we need to learn how to convert its wave motion to the customized power for our ships, for our existing littoral settlements and our future ocean settlements. Here is an attempt to develop method of the conversion the wave energy to power with floating means based on a gyroscope strong capability to resist against the outer force moment trying to tilt it to any side. The gyroscope is used as the fulcrum torque dynamic supporting instead traditional static base used in the issued devices. Alternate force moment created by the waves and transmitted to the gyroscope (via the floating body and the wave energy converter) inducts alternative gyro precession so as the gyroscope axis hesitates about mean position. This is important because it allows the gyroscope to keep dynamic fulcrum torque in unlimited time. The few gyroscope precession control devices and methods have been developed to compensate other reasons enforcing the mean gyro axis to drift from initial plumb. Also here are developed the new ship architecture with the separated floating gyro section. The wagging propulsor driven by the pitching and with strokes amplified by the fulcrum gyro section, the spring moment generator for the gyroscope drift compensation, non gyroscope floating power station able to derive, convert, accumulate and transmit wave energy to consumer also have been developed here.

U.S. Pat. No. 4,050,849 to Sheets teaches an invention related to a hydrodynamic transmission for ship propulsion comprising a prime mover driving an axial flow pump in combination with an open, water-powered turbine for driving propeller blades. The power plant and the propeller are not mechanically connected, and power is transmitted through the hydrodynamic transmission. The invention also provides for a thrust-reversing mechanism specially adapted to the hydrodynamic transmission described herein.

U.S. Pat. No. 6,419,538 to Diaz teaches a system for marine propulsion including a metal fuel slurry, a water plasma, and a high alternating magnetic field. The magnetic field acts on the metal fuel to generate explosive momentum via a metal-water reaction.

U.S. Pat. No. 4,767,364 to Lenz teaches a steering and propulsion system for a ship, including two side by side, fore and aft pipes underneath a ship's hull, and compressed air or steam delivered through tubes around an exterior of the hull to the two pipes, and controls to eject forwardly or rearwardly out from the pipes.

### SUMMARY OF THE INVENTION

It is therefore an object of the present invention to provide energy sources other than diesel fuel to power large displacement ships including container vessels, bulk carriers, tankers, warships, and freighters. In some embodiments combinations of energy sources are employed to drive a ship for a lower requirement of fossil fuels and with less air pollution produced.

The invention includes a hybrid ship-based propulsion system including a ship; an onboard power plant, wherein the power plant has a dedicated function not related solely to the ship's propulsion; and, one other source of energy for providing propulsion for the ship.

In one aspect of the system, the ship is involved in desalination.

In another aspect of the system, the ship is involved in oil exploration.

In another aspect of the system, the other source of energy is derived from solar energy

In another aspect of the system, the other source of energy is derived from wave energy.

In another aspect of the system, the other source of energy is derived from high altitude wind flow.

In another aspect of the system, the high-altitude kites are employed in capturing the energy from the high altitude wind flow.

In another aspect of the system, the other source of energy is derived from batteries.

In another aspect of the system, the batteries are capable of recharging.

In another aspect of the system, the other source of energy is derived from hydrogen.

The invention includes a method for providing propulsion energy to a ship, including: providing a ship; directing energy of an onboard power plant to drive at least one propeller of the ship; and, providing at least one more source of energy to drive the at least one propeller, wherein the at least one more source of energy is renewable.

In one aspect of the method, there is an additional step of combining energy from the power plant and the at least one more source of energy prior to delivering energy to the at least one propeller.

In another aspect of the method, there is additionally a computer-based device for selecting source of energy for delivery to said at least one propeller.

In another aspect of the method, the at least one more source of energy is the sun.

In another aspect of the method, the said at least one more source of energy is high-altitude wind.

In another aspect of the method, the at least one more source of energy is ocean waves.

In another aspect of the method, the at least one more source of energy is hydrogen extracted from ocean water.

The invention includes a hybrid ship-based propulsion system including a ship; an onboard desalination power plant, wherein the desalination power plant is primarily used to generate drinking water from sea or brackish water; and, one other source of energy for providing propulsion energy for said ship, wherein the source of energy is renewable.

In one aspect of the system, the power plant has an output capacity of between 22 and 220 MW.

In another aspect of the system, the power plant runs on natural gas.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 shows a schematic view of a power plant providing energy to a ship's propeller;

FIG. 2 shows a schematic view of a power plant and a solar energy apparatus providing energy to turn a ship's propeller;

FIG. 3 (A and B) shows schematic views of a power plant and a wave energy device providing energy to turn a ship's propeller;

FIG. 4 shows a schematic view of a power plant and a high altitude kite system providing energy to turn a ship's propeller;

FIG. 5 shows a schematic view of a power plant and an on-board hydrogen generation system providing energy to turn a ship's propeller; and,

FIG. 6 shows a flowchart for a method associated with the present invention.

### DETAILED DESCRIPTION OF EMBODIMENTS

### Description of the Preferred Embodiment

In the following description, numerous specific details are set forth in order to provide a thorough understanding of the present invention. It will be apparent, however, to one skilled in the art that the present invention may be practiced without these specific details. In other instances, well-known circuits and control logic have not been shown in detail in order not to unnecessarily obscure the present invention. The following definitions are for aiding in understanding the present invention.

### DEFINITIONS

Certain terms are now defined in order to facilitate better understanding of the present invention.

Many terms will have their generally accepted meanings within the context of the present invention. Terms not specifically defined otherwise may have their generally accepted meaning.

“Vessel” or “large ship” or “large displacement vessel” may generally refer to water-going ships with displacements of 50,000 metric tons or more. While the present invention may have applicability to ships and boats of all sizes, a purpose of the present invention is to protect valuable cargo and crew carried by large transport ships plying international waters.

Megawatts may be represented by “MW” and has its normal meaning in the physical arts.

“Renewable” with respect to energy may generally refer to energy derived from sources that are not used up in producing said energy. Renewable energy sources include but are not limited to the sun, wind, and waves, and hydrogen derived from ocean water.

“Power plant” may refer to a device, element or system that converts energy from one source into a power application. A power plant thus may, by example, burn natural gas or coal and use the generated power for performing desalination or oil drilling. A power plant for the present invention is generally rated between 22 MW and 220 MW, though larger or smaller units may be used.

“High altitude” wind may generally refer to wind flow at an altitude of at least 800 meters. A “kite” for the present invention may convert energy from high altitude wind into mechanical or electrical energy for use in driving at least one propeller.

The vast majority of freighters, oil tankers and the like run on diesel fuel. As such, they are generally noisy and produce high levels of both air and water pollution. Ships often contain hundreds of thousands of gallons of fuel, an amount that demands a significant portion of a ship's hold space. Ideally, the world would benefit from reduced diesel use at several levels. Reduction in greenhouse gases, reduction in noise and water pollution, and increased space for valuable cargo are just a few of the benefits in replacing diesel-based ship propulsion with alternatives.

Many ships include electric power plants for specific applications. For example, ship that perform desalination operations, drill for oil, pull other boats or lift large loads all require on board power plant with an output capacity of more than 20 MW.

Having both a large power plant on board with its required fuel, as well as a traditional diesel engine system on board with its required fuel is redundant. Thus, the present invention enables ships that carry or can carry power plants to significantly reduce the billions of gallons of fuel used annually through the removal of this redundancy and the reuse of the onboard power plant for ships propulsion. In some embodiments, the on board power plant may be augmented or replaced with an additional “green” (renewable) energy sources. In other embodiments, a power plant alone may be employed, while in still others, a power plant in combination with one or more renewable fuel sources could allow for complete replacement of traditional diesel seafaring power systems.

### First Embodiment

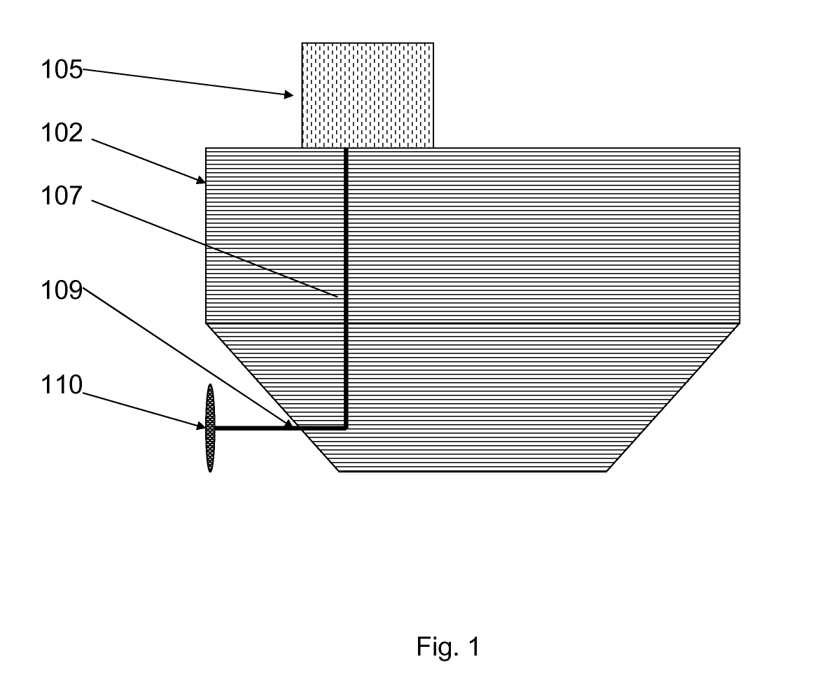

Attention is turned to FIG. 1, which shows a schematic embodiment of the present invention. Vessel 102 includes a power plant 105 which is connected 107 to the drive shaft 109 of a propeller 110. To note, the present invention retains propeller-based ship propulsion and changes the source of energy used for driving said propeller 110. Instead of a diesel-based system which would require engine, all supporting machinery and equipment, as well as tens to hundreds of thousands of gallons of fuel, the present invention would make use of a power plant 105 and its associated fuel, which may include natural gas or possibly renewable energy sources (not shown). The present invention is based in part in the fact that in many seafaring applications, a ship either travels between points or engages in a particular activity. For example, a desalination ship may travel hundreds of kilometres to a point where it begins to work. At that location, the ship drops anchor and begins converting seawater to drinking water and waste brine. Alternatively, an exploration drilling vessel will travel to a predetermined location, where it too will set anchor prior to drilling in the seabed in search of oil, natural gas, or other valuable products.

The state of affairs described above implies that a heavy-duty power plant (>20 MW rating) will generally only be used when the ship on which it is present comes to a stop. The implication is that, instead of remaining idle during navigation, the power plant could serve for ship propulsion (when there is no drilling, desalination or the like) and when the ship comes to rest, the power plant would be available for its intended use. Under such conditions, there would be no further need for a diesel engine, its associated machinery or the vast storage required for its fuel. FIG. 1 represents an embodiment in which only a power plant 105 is used to provide energy for rotation of at least one propeller 110.

### Second Embodiment

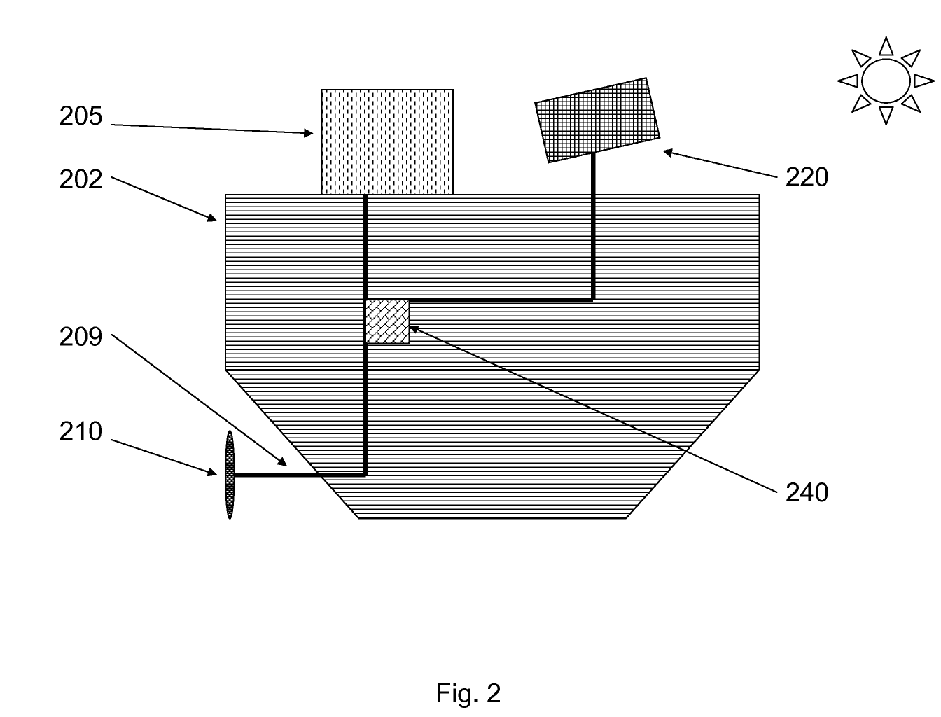

Attention is now turned to FIG. 2 which shows an alternative embodiment of the present invention. Power plant 205 used in desalination operations is present on vessel 202. Due to the size of the vessel 202, additional energy is required for both propulsion of vessel 202 and desalination. A solar energy system 220 is present on vessel 202 for converting sunlight into electrical energy that may be used for driving a driveshaft 209 of a propeller 210 associated with vessel 202. The solar energy system 220 may be a mirror-based solar-thermal system or may employ any method for converting solar energy into electricity used for driving propeller 210. A computer 240 can determine the balance in use of power plant 205 or solar energy system 220 at any given time for propelling vessel 202. During very sunny days, the solar energy system 220 may be primary, whereas at night, the vessel 202 might rely solely on the power plant 205 for providing power to drive the driveshaft 209 of vessel 202.

### Third Embodiment

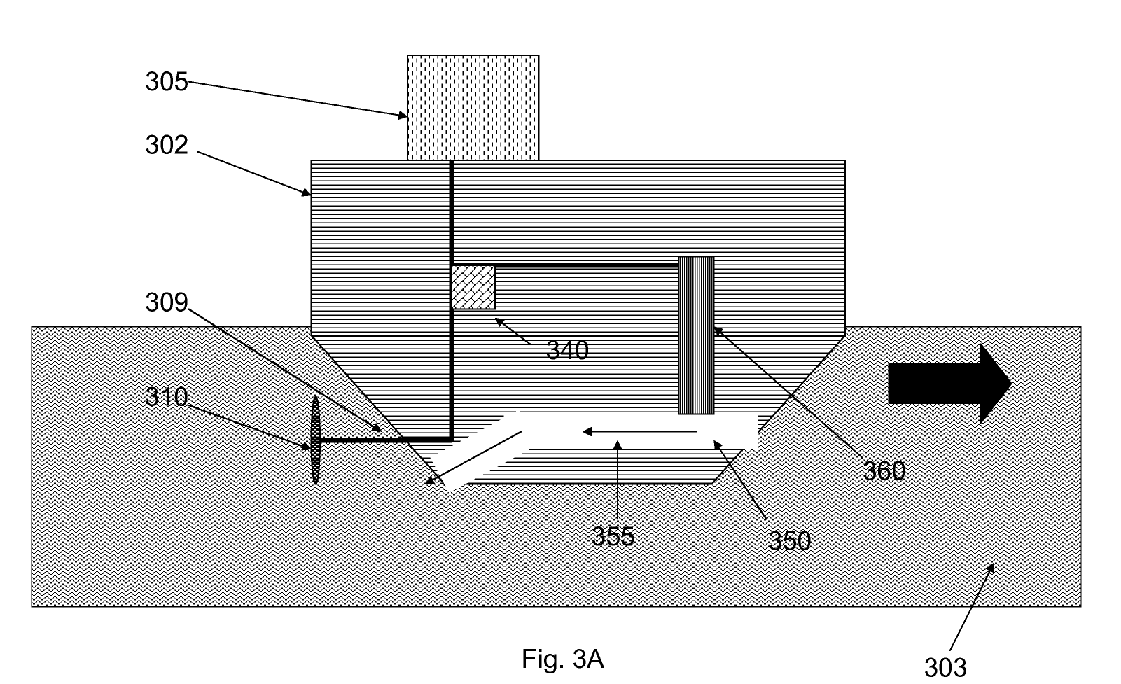

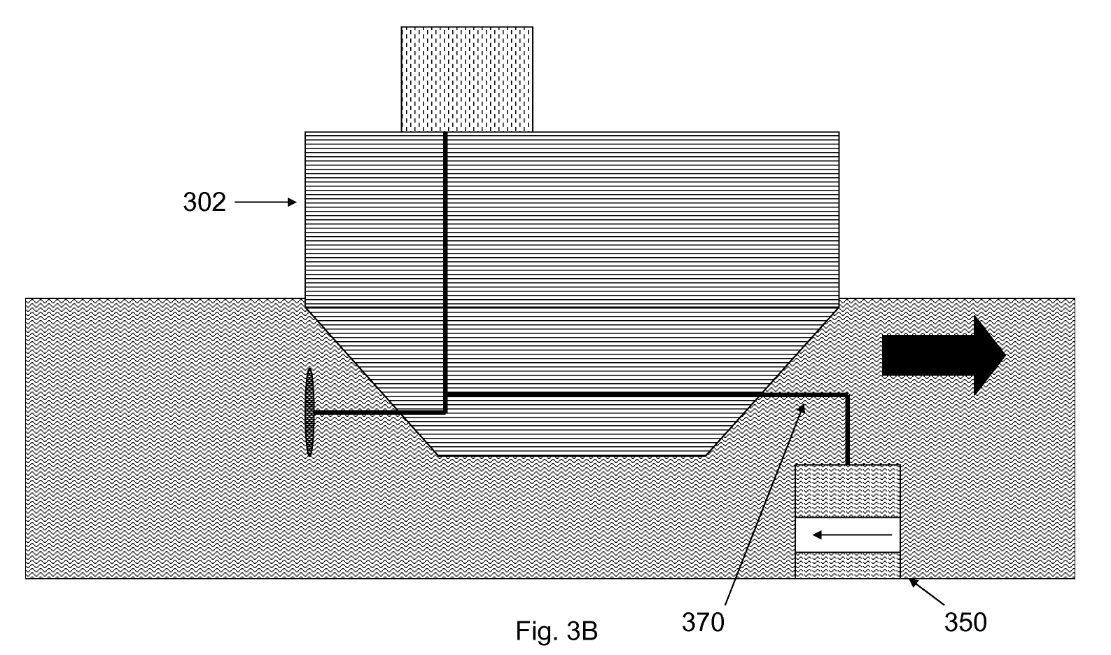

Attention is turned to FIG. 3A which shows an embodiment of the present invention. Vessel 302 moving through water (303) (arrow indicates direction of vessel 302) includes an electricity-producing power plant 305 of greater than 20 MW rating for driving a propeller 310. It additionally includes a wave energy receiving component 350. The wave energy receiving component 350 can convert wave and/or water flow 355 into electricity through an associated wave energy to electrical energy conversion element 360. A computer 340 can determine the balance of power supplied to driveshaft 309 and thus propeller 310 from power plant 305 and conversion element 360. The computer can continuously balance energy being delivered from the power plant 305 and the conversion element 360 to driveshaft 309 so as to allow for the most efficient use of energy resources. Quiet seas may require more power plant 305 power based on converting natural gas or the like to electricity while stormy seas may yield more wave power usage.

Attention is turned to FIG. 3B that shows an additional embodiment of the invention. In this embodiment, a wave energy receiving component 350 is physically separate from vessel 302 though the two are tethered 370. In this embodiment, the conversion element is not shown as a separate element but is rather an integral portion of the wave energy receiving component 350.

### Fourth Embodiment

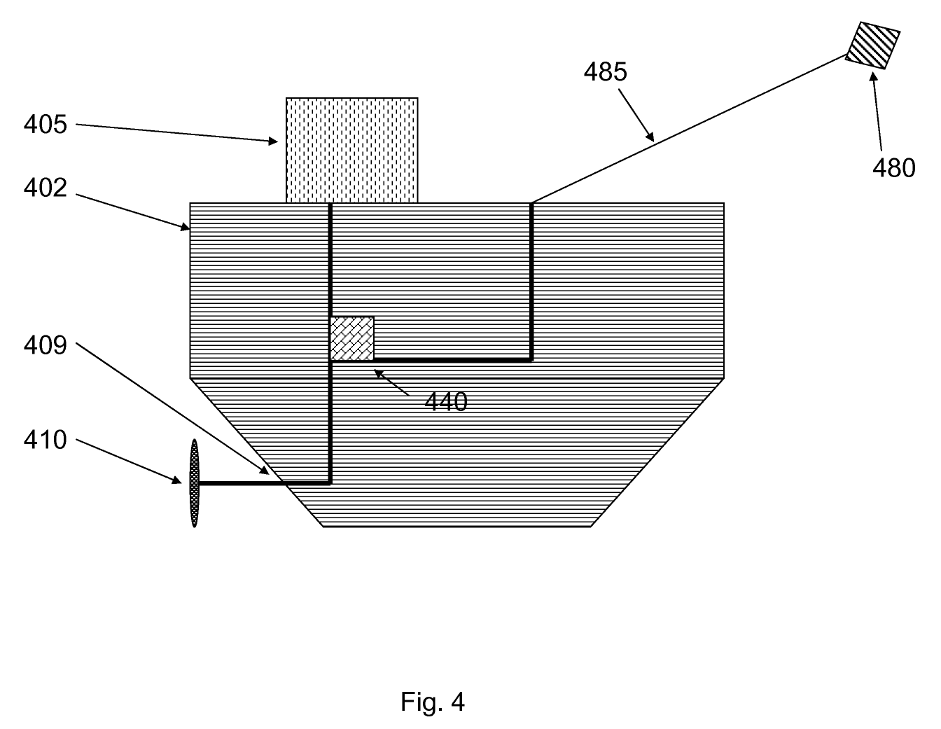

Attention is now turned to FIG. 4 which shows an alternative embodiment of the present invention. A vessel 402 includes a power plant 405 that provides energy to a driveshaft 409 driving at least one propeller 410. Additionally, a high-altitude kite 480 is used to harness energy provided by the exceptionally strong winds round above 800 meters in the atmosphere. Electricity may generally move down line 485 from the wind-driven kite 480 to a computer 440 or electricity may be delivered to the vessel 402 by other means. A computer 440 determines the ratio of energy from power plant and high-altitude kite 480 for delivery to driveshaft 409. When little wind is present, most of the energy will be provided by power plant. In cases when very powerful wind flow is converted by said kite 480 to electrical energy, the computer 440 will deliver less energy from the power plant 405. And as mentioned previously, when the power plant 405 is involved in a task such as desalination or drilling, any energy needed for running the vessel can be provided by the high-altitude kite 480.

### Fifth Embodiment

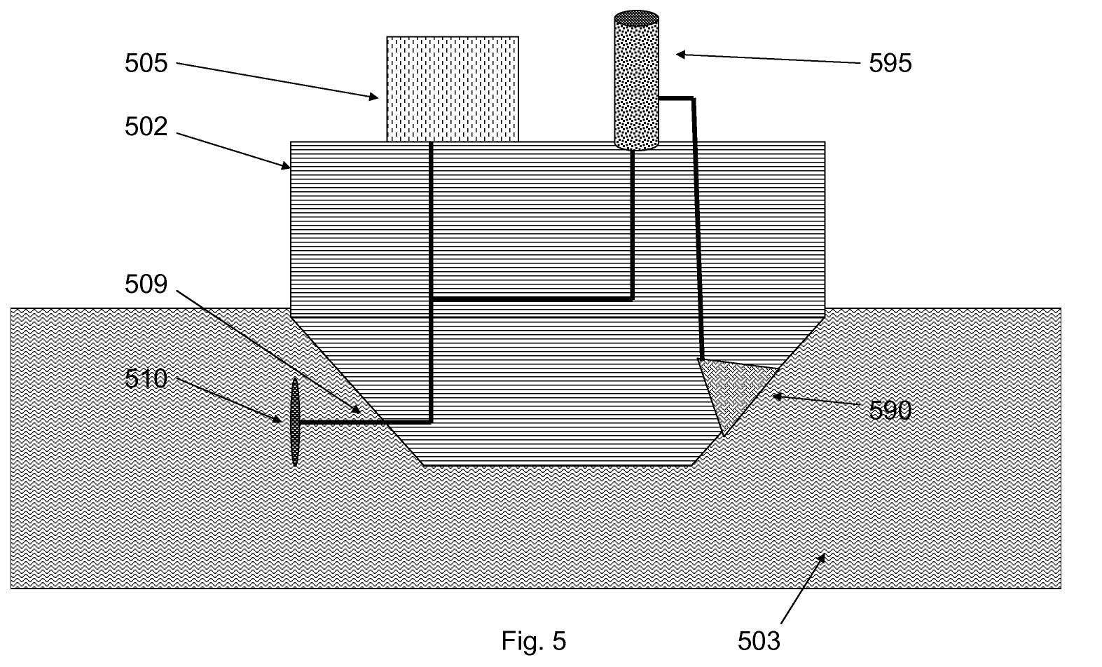

Attention is turned to FIG. 5 which shows an alternative embodiment of the present invention. A vessel 502 with a power plant 505 includes a water 503 to hydrogen converter 590 which transfers hydrogen to a hydrogen storage unit 595. Hydrogen may be stored in the storage unit 595 as a gas or liquid. Oxygen produced by electrolysis or other means from water 503 may also be used and/or stored (not shown). The hydrogen may be used as a fuel for driving the driveshaft 509 attached to a drive propeller 510. Hydrogen may be produced and stored by any means and it may be converted to energy by any means, including but not limited to ignition or fusion. Hydrogen burned or otherwise converted to electricity may be used in providing energy for driving vessel 502 propeller.

### Sixth Embodiment

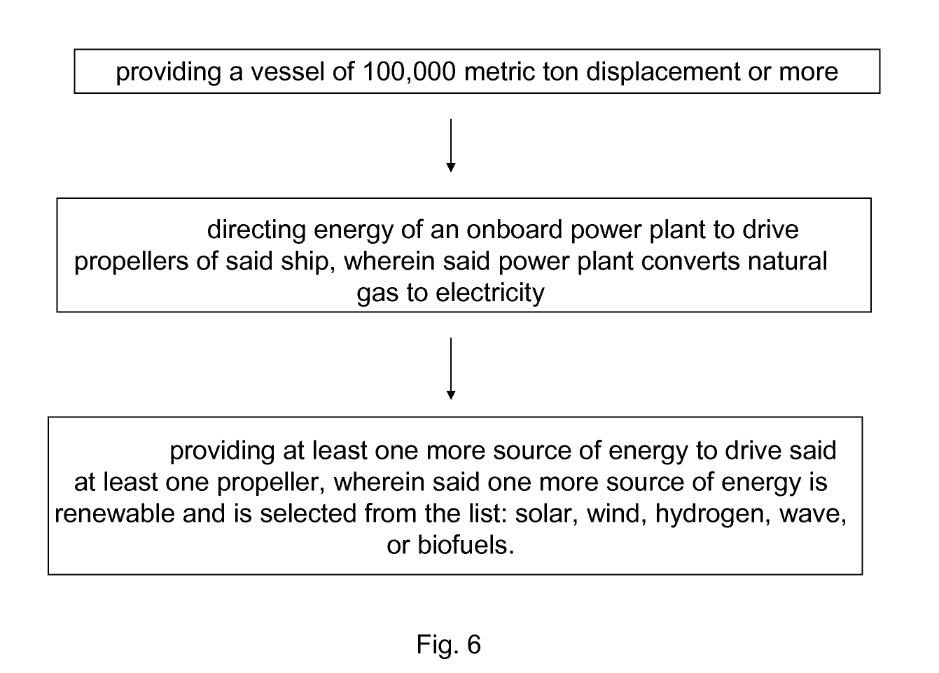

Attention is now turned to FIG. 6 which shows a method associated with the present invention. The method allows for the complete replacement of diesel-based propulsion of a large ship. The method includes the following: providing a vessel of 100,000 metric ton displacement or more; directing energy of an onboard power plant to drive propellers of said ship, wherein said power plant converts natural gas to electricity; and, providing at least one more source of energy to drive said at least one propeller, wherein said one more source of energy is renewable and is selected from the list: solar, wind, hydrogen, wave, or biofuels.

### Some Benefits of the Use of the Present Invention

The usefulness of the present invention is typically evident in the following ways:
a) The present invention allows for a significant reduction in diesel use in world freight transfer and other seafaring activities.
b) The present invention makes best use of power plants dedicated to non-propulsion activities by using the same power plants to drive the ships on which they are located—and thus completely replace a diesel motor and its associated elements.
c) The systems described herewith allows for the use of renewable energy on a backbone of natural gas burning power plant. Thus, one does not rely fully on renewable energy which is not always available (wind, solar, and wave vary with time and location), but rather judiciously adds renewable energy as available to reduce the power plant contribution to ship propulsion.
d) The invention will lead to less noise and water pollution.

It will be appreciated by persons skilled in the art that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description. Accordingly, it is intended to embrace all such alternatives, modifications and variations that fall within the scope of the appended claims.

1. A hybrid ship-based propulsion system including
a ship;
an onboard power plant, wherein said power plant has a dedicated function not related solely to said ship's propulsion; and,
one other source of energy for providing propulsion for said ship.

2. The system according to claim 1, wherein said ship is involved in desalination.

3. The system according to claim 1, wherein said ship is involved in oil exploration.

4. The system according to claim 1, wherein said other source of energy is derived from solar energy.

5. The system according to claim 1, wherein said other source of energy is derived from wave energy.

6. The system according to claim 1, wherein said other source of energy is derived from high altitude wind flow.

7. The system according to claim 6, wherein high-altitude kites are employed in capturing said energy from said high altitude wind flow.

8. The system according to claim 1, wherein said other source of energy is derived from batteries.

9. The system according to claim 8, wherein said batteries are capable of recharging.

10. The system according to claim 1, wherein said other source of energy is derived from hydrogen.

11. A method for providing propulsion energy to a ship, including:
providing a ship;
directing energy of an onboard power plant to drive propellers of said ship; and,
providing at least one more source of energy to drive said at least one propeller, wherein said one more source of energy is renewable.

12. The method according to claim 11, further including the step of combining energy from said power plant and said at least one more source of energy prior to delivering energy to said at least one propeller.

13. The method according to claim 11, further including a computer-based device for selecting source of energy for delivery to said at least one propeller.

14. The method according to claim 11, wherein said at least one more source of energy is the sun.

15. The method according to claim 11, wherein said at least one more source of energy is high-altitude wind.

16. The method according to claim 11, wherein said at least one more source of energy is ocean waves.

17. The method according to claim 11, wherein said at least one more source of energy is hydrogen extracted from ocean water.

18. A hybrid ship-based propulsion system including
a ship;
an onboard desalination power plant, wherein said desalination power plant is primarily used to generate drinking water from sea or brackish water; and,
one other source of energy for providing propulsion energy for said ship, wherein said source of energy is renewable.

19. The system according to claim 18, wherein said power plant has an output capacity between 22 and 220 MW.

20. The system according to claim 18, wherein said power plant runs on natural gas.
